(19) United States
(12) Patent Application Publication
(10) Pub. No.: US 2011/0279111 A1
(43) Pub. Date: Nov. 17, 2011

(54) Electronic probe housing and electronic governor for steam turbine

(76) Inventors: James Leon Jacoby, JR., Sugarland, TX (US); Sridhar Madala, Houston, TX (US); Timothy A. Pieszchala, Seabrook, TX (US)

(21) Appl. No.: 13/066,263

(22) Filed: Apr. 11, 2011

Related U.S. Application Data
(63) Continuation-in-part of application No. 12/800,213, filed on May 11, 2010.
Application No. 12/800,213 is a continuation-in-part of application No. 12/932,795, filed on Mar. 7, 2011.

(51) Int. Cl. G01B 7/30

(52) U.S. Cl. 324/207.25

(57) ABSTRACT

An electronic housing having two speed pickup devices automatically sends electric signals to an electronic governor which causes the RPM of the steam turbine to increase, decrease or remain constant, in conjunction with software and electronic circuitry for controlling the management of a plurality of power sources for the electronics and minimizing the amounts of power used in such electronics.

### RELATED APPLICATION

This application is a continuation-in-part, of U.S. patent application Ser. No. 12/800,213, filed May 11, 2010, for ELECTRONIC PROBE HOUSING FOR STEAM TURBINE, and also is a continuation-in-part, of U.S. patent application Ser. No. 12/932,795, filed Mar. 7, 2011, for ELECTRONIC PROBE HOUSING AND AUTOMATIC SHUTOFF FOR STEAM TURBINE.

### BACKGROUND OF THE INVENTION

Steam turbines have been well known in the art for many years, with the modern steam turbine having apparently been invented by the Englishman Sir Charles Parsons in 1884, an invention which was later scaled-up by the American George Westinghouse. The classic steam turbine, in perhaps its most simplistic form, is illustrated as prior art in FIG. 1A, showing the entry of steam to cause the turbine blades to spin, which in turn causes a generator to spin, thus spinning the generator to produce electricity. The steam enters the apparatus of FIG. 1A through one or more valves, it being known that the rotational speed of the turbine is controlled by the varying of the number of valves, and/or by positioning of such valves and/or by changing the volumetric opening through such one or more such valves.

It is also well-known in this art to use a governor with the valve system discussed above to control the rotational speed of the turbine by controlling the steam flow.

It is also known in this art to use microprocessor based control systems marketed by the Woodward Governor Company, located at 1000 East Drake Road, Fort Collins, Colo. 80525, designed to function with speed monitors available from other sources.

Moreover, it is known in the prior art to measure the rotational speed, i.e., the timed number of revolutions of the turbine shaft, to control the hydraulic actuators involved with the controlled movement of the valves and thus control of the steam turbine. These types of known systems are described in detail in U.S. Pat. No. 4,461,152 to Yashuhiro Tennichi and Naganobu Honda, and in U.S. Pat. No. 4,658,590 to Toshihiko Higashi and Yasuhiro Tennicho.

### BRIEF DESCRIPTION OF DRAWINGS

FIG. 1A is a pictorial, simplistic view of a steam turbine well known in the prior art;

FIGS. 1B and 1C are block diagrams of a steam turbine system using an electronic probe housing in combination with a governor, a steam governoring valve, a steam turbine and a rotatable load according to the invention;

FIG. 1D is a pictorial view of a worm and worm gear as used in FIG. 1C.

FIG. 2 is a pictorial view of the electronic probe housing according to the invention;

FIG. 3 is a pictorial view of the electronic probe housing according to the invention;

FIG. 4 is a pictorial view of the electronic probe housing according to the invention;

FIG. 5A is a top plan view of the end cap used with the electronic probe housing according to the invention;

FIG. 5B is a cut-away side view of the end cup illustrated in FIG. 5A according to the invention;

FIG. 6A is a top plan view of the back plate of the electronic probe housing according to the invention;

FIG. 6B is a cut-away view of the back plate illustrated in FIG. 6A;

FIG. 7 is a pictorial side view of a short section of drive shaft used inside the electronic probe housing according to the invention;

FIG. 8A is a top plan view of a gear ring according to the invention;

FIG. 8B is a cut-away side view of the gear ring illustrated in FIG. 8A according to the invention;

FIG. 9A is a pictorial view of the sub-housing used with the electronic probe housing of FIGS. 2A, 3A and 4A according to the invention;

FIG. 9B is a top plan view of the sub-housing illustrated in FIG. 9A;

FIG. 10 is a pictorial view of the electronic probe housing prior to being assembled according to the invention;

FIG. 11 is a pictorial view of two of the magnetic sensor probes used in accordance with the invention;

FIG. 12A is a non-specific, generalized block diagram of a self powered governor according to the invention;

FIG. 12B is a block diagram of the self powered turbine generator according to the present invention

FIG. 13 is a more specific block diagram describing in more detail the functions illustrated in FIG. 12A according to the invention'

FIG. 14 is a block diagram illustrating the sequence of events involving the functions illustrated in the block diagram in FIG. 13;

FIG. 15 is a schematic circuit for supplying electrical power from a variety of different power sources to run the electronic governor according to the invention;

FIG. 16 is a schematic circuit for harvesting the electrical power from one or more magnetic pick up devices according to the invention;

FIG. 17 is a schematic circuit for isolating a power source according to the invention; and

FIG. 18 is a block diagram of the various functions and modes used in the electronic governor according to the invention.

### DETAILED DESCRIPTION OF PREFERRED EMBODIMENT OF INVENTION

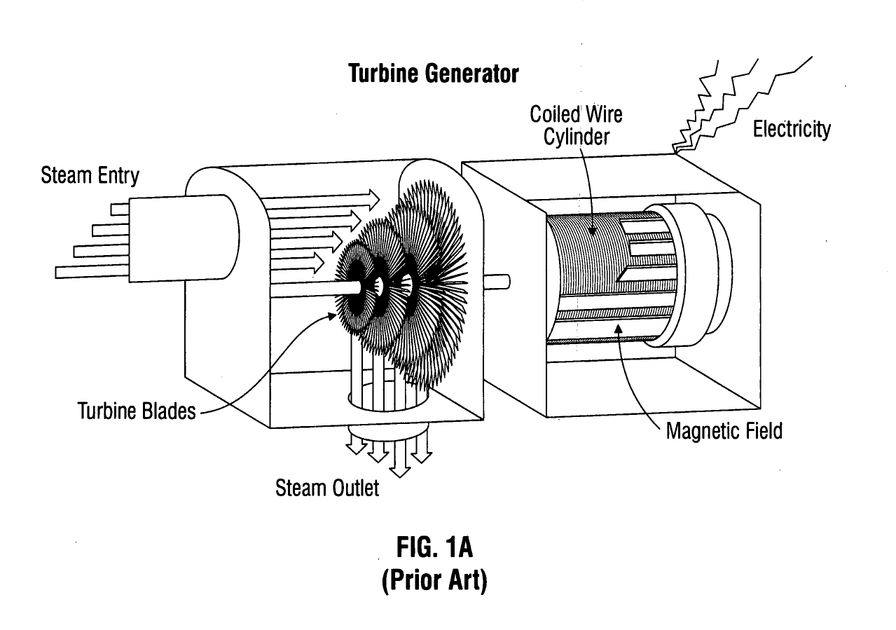

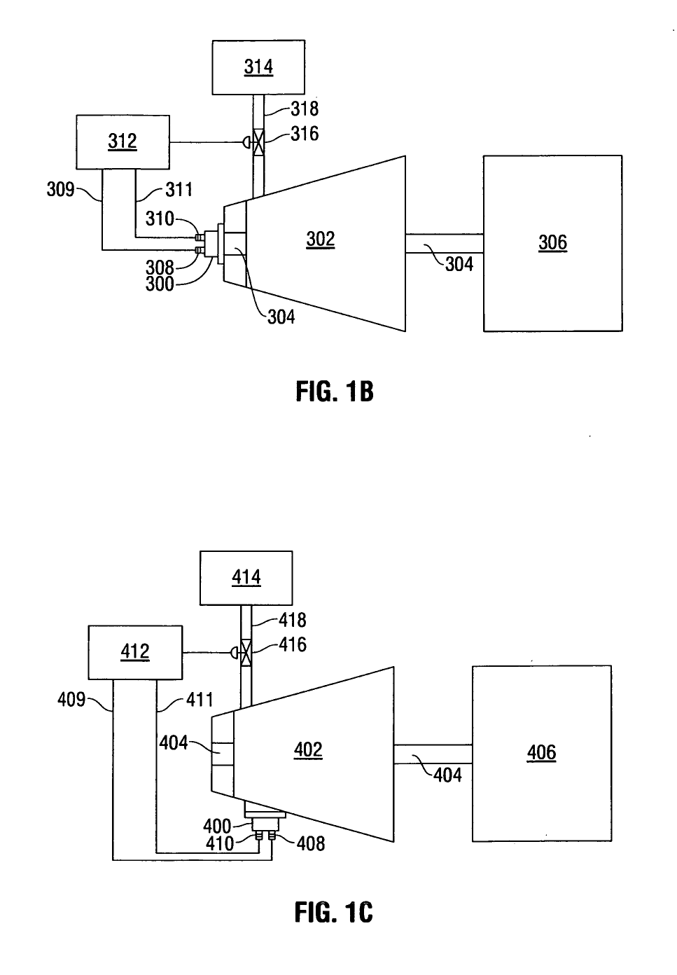

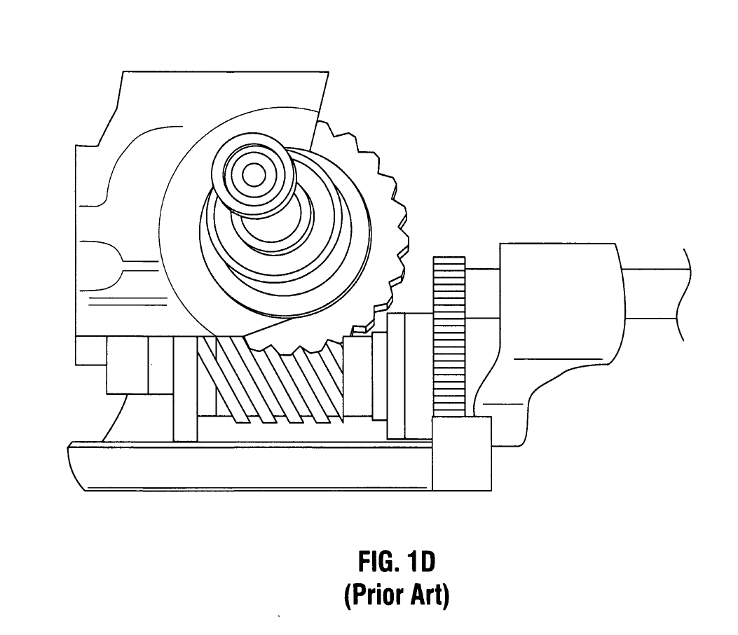

FIG. 1A illustrates a typical steam turbine generator, well-known in the prior art, in which steam enters the turbine to thus cause the turbine blades, mounted on a rotatable shaft, to spin a generator to produce electricity. Such steam turbines are also used to drive other rotatable equipment such as motors, compressors, pumps and the like. Such prior art steam turbines typically use positionable valves (not illustrated in FIG. 1A) to control the steam impacting the turbine blades to thus control the speed of rotation of the shaft.

It is known in the prior art to measure the pressure of the steam as the steam exits the enclosure around the turbine blades, since such steam pressure differential, up or down, is an indication of the changes in the speed of rotation of the drive shaft. For example, if the steam pressure from the exit port decreases, the one or more steam valves can be manipulated manually to thereby increase the speed of shaft rotation up to a desired level.

It is also known in this art to locate an electronic sensor on or near the drive shaft, with a visual sensor, and when the sensor provides a visual indication of speed change to a technician or engineer, such technician or engineer can then manually adjust the steam valve or valves to thereby adjust the speed of rotation of the drive shaft.

FIG. 1B illustrates in block diagram the electronic probe housing 300 according to the present invention in use with a steam turbine 302 having a rotatable drive shaft 304 between the housing 300 and the turbine 302, and between the turbine 302 and the load 306, which may be any rotatable equipment, such as a generator, a pump, a compressor or the like.

FIG. 1B also illustrates a pair of magnetic pickup sensors 308 and 310 coming out of the probe housing 300, and having electrical lines 309 and 311 leading into the electronic governor 312. A source of pressurized steam 314 is connected through one or more valves 316 in steam pipe 318 into the steam turbine 302 to drive the turbine blades therein.

FIG. 1C illustrates in block diagram the electronic probe housing 400 according to the present invention in use with a steam turbine 402 having a rotatable drive shaft 404 between the housing 400 and the turbine 402, and between the turbine 402 and the load 406, which may be any rotatable equipment, such as a generator, a pump, a compressor or the like.

FIG. 1C also illustrates a pair of magnetic pickup sensors 408 and 410 coming out of the probe housing 400, and having electrical lines 409 and 411 leading into the electronic governor 412. A source of pressurized steam 414 is connected through one or more valves 416 in steam pipe 418 into the steam turbine 402 to drive the turbine blades therein.

The only difference between the embodiments of FIGS. 1B and 1C is the use of a conventional worm and a worm gear, illustrated in FIG. 1D within the steam turbine 402 which causes the drive shaft 404 to exit the lower side of the steam turbine 402 instead of at the back side of the steam turbine. As is well known, the worm gear drive has its drive axes at 90° to each other, and is typically used to decrease speed and to increase torque.

The electronic governors 312 and 412 are preferably identical as to the mechanical and electronic parts used therein and functions thereof, and are described in more detail hereinafter.

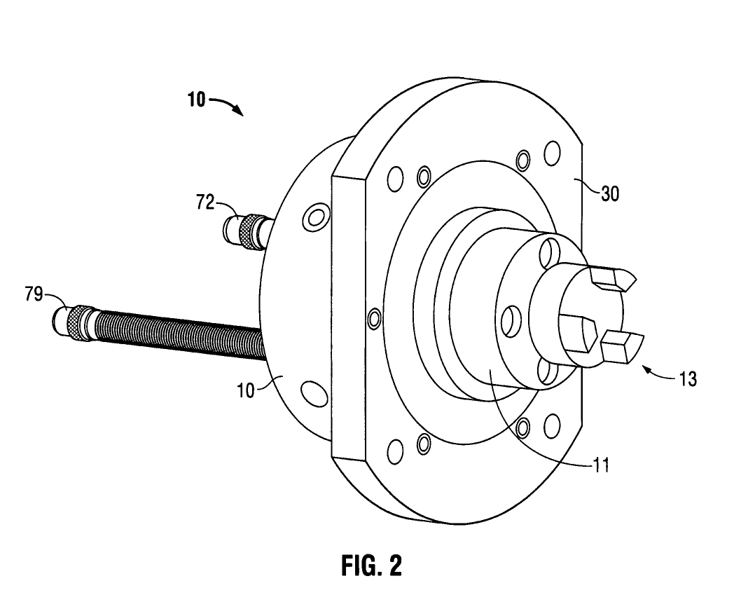

FIGS. 2, 3 and 4 pictorially illustrate an electric probe housing 10 according to the invention, the individual components of which are illustrated and described hereinafter in greater detail.

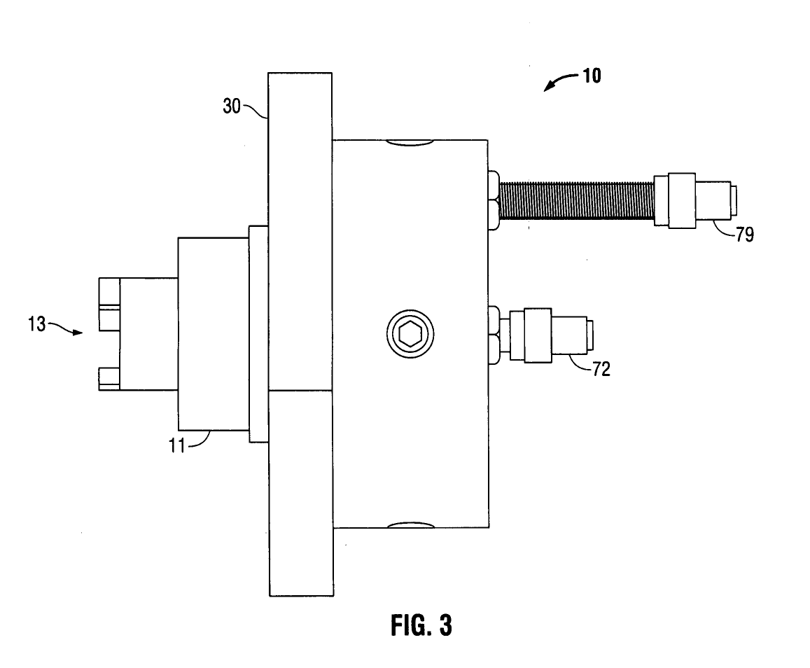

FIGS. 2 and 3 illustrate in two views the completely assembled electronic probe according to the invention, including the end cap 11, the back plate 30, the housing 10 and the probes 72 and 79. The known coupling 13 is commercially available from Lovejoy, Inc., preferable their Model “1”, located at 2655 Wisconsin Avenue, Downers Grove, Ill. 60515. This coupling is used to connect the second end of the small drive shaft 32 to the main drive shaft.

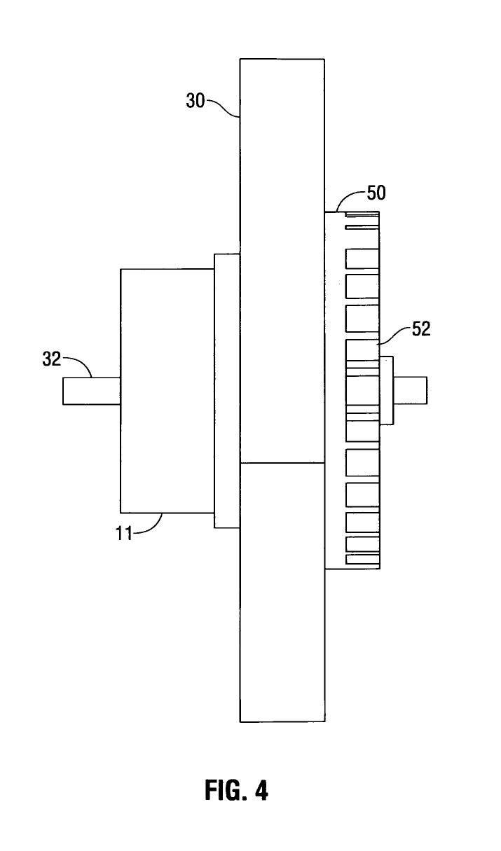

FIG. 4 illustrates the partial assembly of the electronic probe according to the invention, illustrating the gear ring 50 and its extensions 52, but not yet showing the remainder of the housing 10 which will surround and enclose the gear ring 50 as illustrated in FIGS. 2 and 3, and does not yet show the fixture 12 as is illustrated in FIGS. 2 and 3.

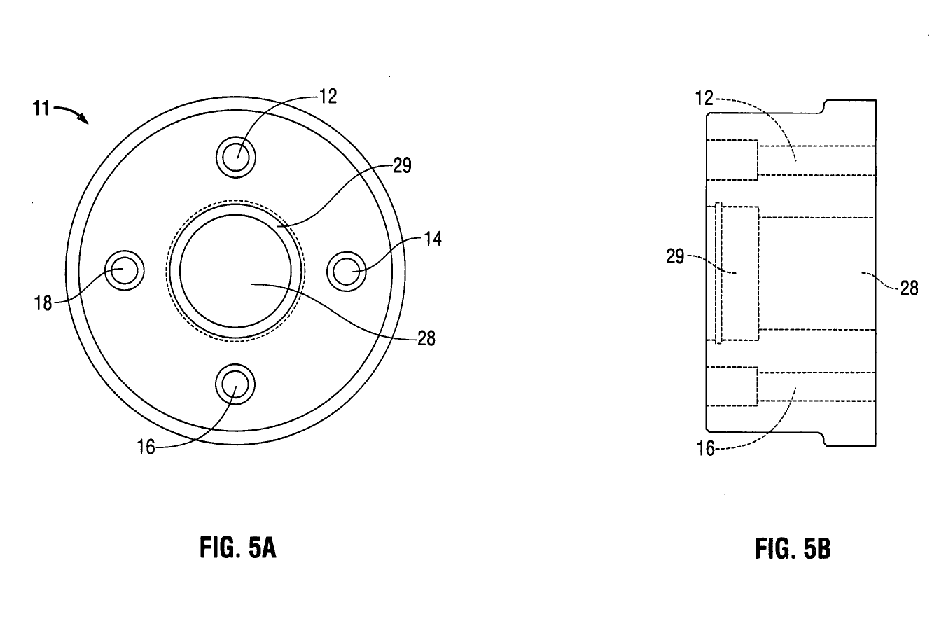

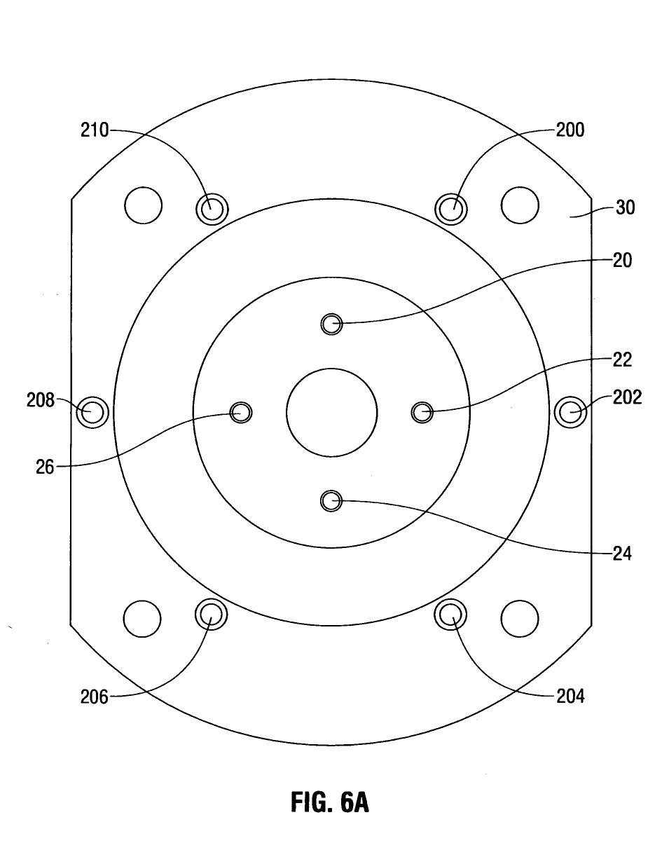

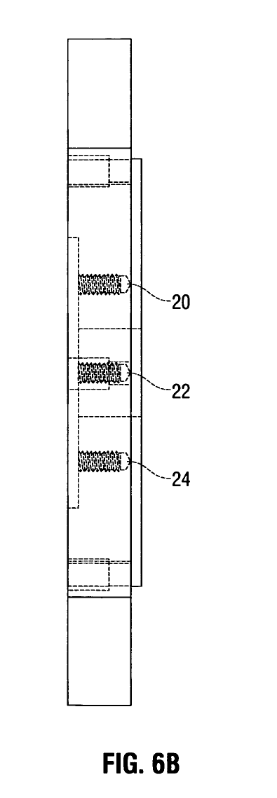

FIG. 5A illustrates a top plan view of the end bearing cylindrical cap 11 associated with the housing 10, and having four mounting thru-holes 12, 13, 14 and 15 to allow the cap 11 to be threadedly connected to the four holes 20, 22, 24 and 26 in the back plate 30 illustrated in a top plan view in FIG. 6A. The housing 10 also has thru-hole 28 and bearing 29 through which a drive shaft 32 extends. FIG. 5B illustrates a cut-away side view of the end cap 10.

Referring further to FIGS. 6A and 6B, the back plate 30 is essentially cylindrical in shape other than for having two of its opposing sides parallel. The plate 30 has a central thru-hole 34 mating with the thru-hole 28 of the cap 10 shown in FIG. 5A. The thru-hole 34 also has a bearing therein, if desired, to facilitate rotation of the shaft 32.

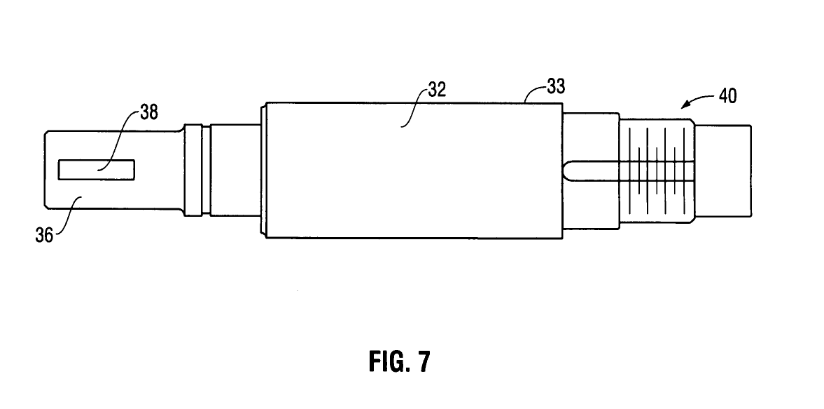

FIG. 7 illustrates a short length of rotatable drive shaft 32 having a central raised surface long enough to snugly fit within the thru-holes 28 and 34 and the bearings therein to avoid vibration. The end 36 of drive shaft 32 preferably has a Woodruff key 38 for attachment to a key seat, all as is well-known in the art for forming a keyed joint between a pair of objects. The other end 40 of the drive shaft 32 has a bearing nut 42.

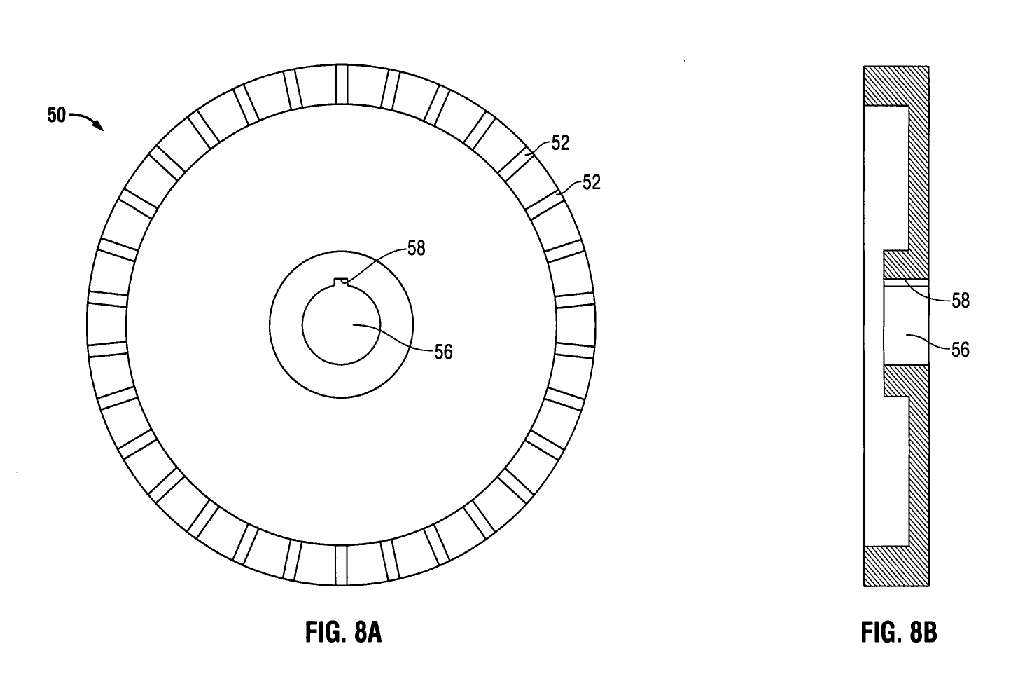

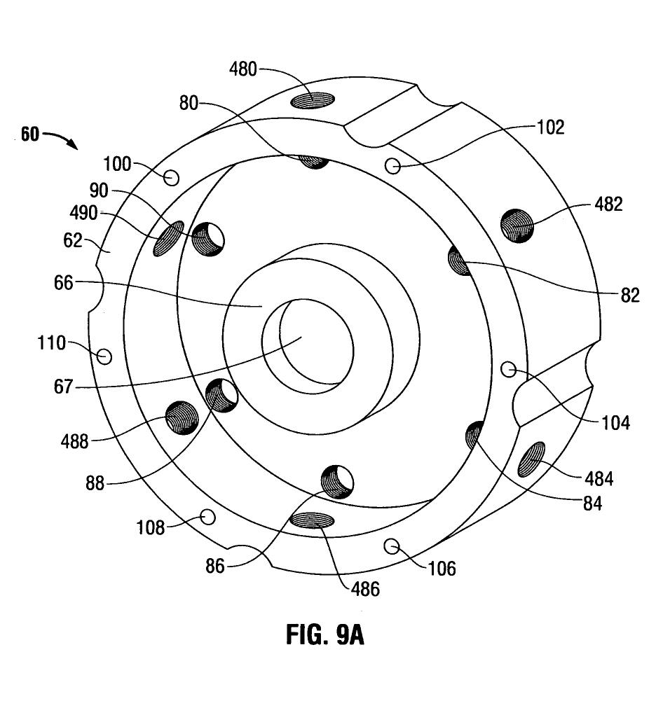

FIG. 8A illustrates a top plan view of a gear ring 50 preferably having thirty extended positions 52, the number thirty for such extended portions being preferable only because alternating current typically is 60 Hz, thus making the calculations and calibrations easier to compute. Some geographic regions are known to use 50 Hz, so it may be appropriate to use twenty five extensions instead of thirty.

The gear ring 50 also has a central raised, cylindrical portion 54 having a thru-hole 56 and a key seat 58 to accommodate a key on the shaft 32 to prevent relative rotation between the gear ring 50 and the shaft 32.

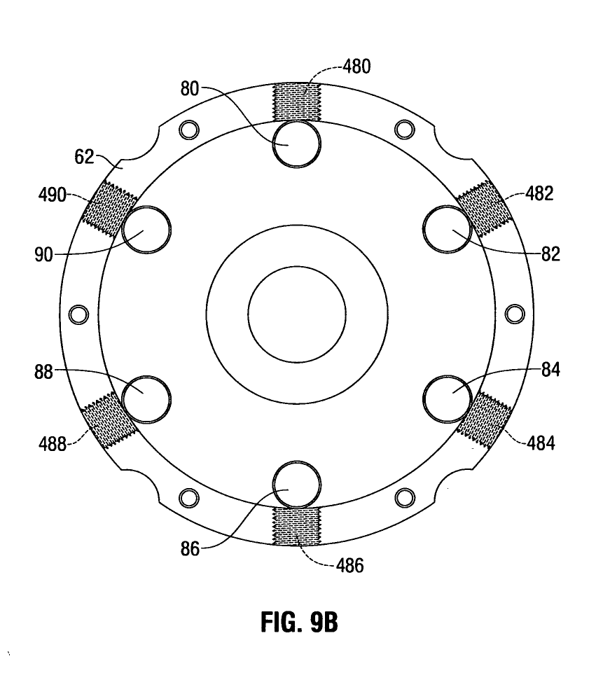

FIG. 9A is a pictorial view of an electronic probe sub-housing 60 having a cylindrical wall 62, a top cover plate 64 and a central, raised portion 66 having an opening 67 partially there-thru to accept the end 40 of the drive shaft 32. The top cover plate 64 of the sub-housing 60 has six (6) holes, 80, 82, 84, 86, 88 and 90 there thru for the insertion of one or more magnetic pickup probes, preferable the two probes 72 and 79.

FIGS. 2, 3, 9A and 9B illustrate a plurality of side holes 480, 482, 484, 486, 488 and 490 through the side wall 62. The side holes are aligned to provide access to the probes (72, 79) inserted through one or more of the holes 80, 82, 84, 86, 88 and 90, thus providing a method for calibrating the air gap between the probe (72, 79) and the extensions 52 in FIG. 8A. For example, side hole 480 aligned with the hole 80, etc.

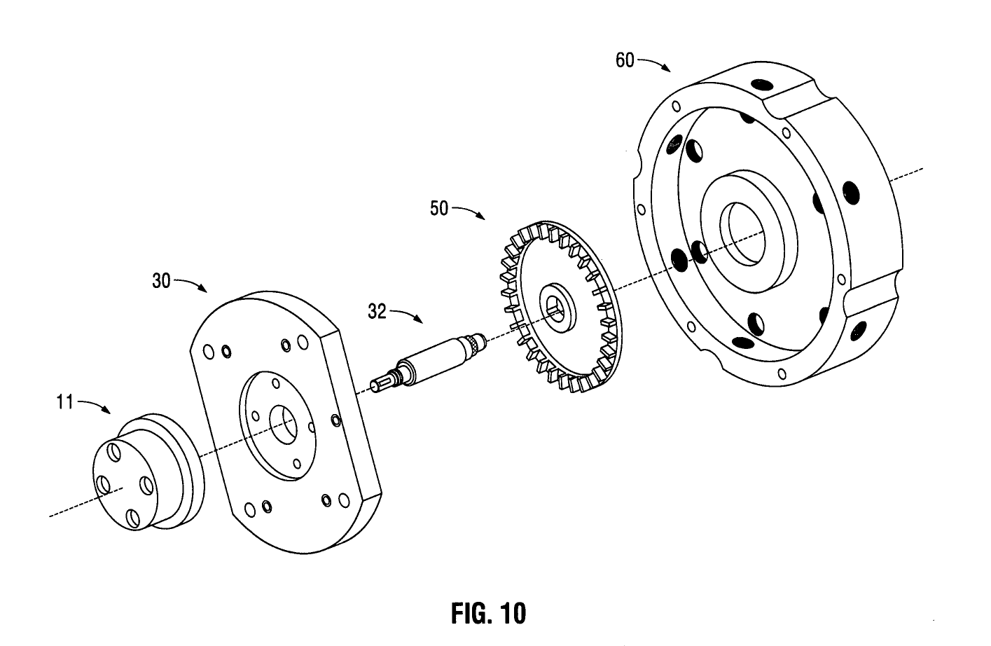

In the assembly of the components illustrated in FIG. 10, the end cap 11 is first threadely attached through the use of threaded bolts through the mounting holes 12, 14, 16 and 18, and the mating holes 20, 22, 24 and 26, respectively. Alternatively, the cap 11 and plate 30 can be cast, milled or otherwise formed as a single component from a castable or millable material, for example, cast iron. The end 36 of draft shaft 32 is inserted within the thru-holes 28 and 34, and then through the thru-hole 56, until the key on the exterior surface of shaft 32 is seated within the key seat 58. With this assembly, the end 40 of the shaft 32 is rotatably seated in the receptacle 67.

Although not illustrated in FIG. 4A, one or more electronic probes (magnetic pickup devices) such as the two probes 72 and 79 can be inserted through two of the thru-holes 80, 82, 84, 86, 88 and 90 to be proximate to the rotating gear ring and its extended elements 52.

The surface 62 of the sub-housing 60 illustrated in FIG. 9A is then moved against the back plate 30, thus enabling the housing 60 and plate 30 to be threaded connected together, through the use of threaded bolts through the holes 100, 102, 104, 106, 108 and 110, and the holes 200, 202, 204, 206, 208 and 210 respectively.

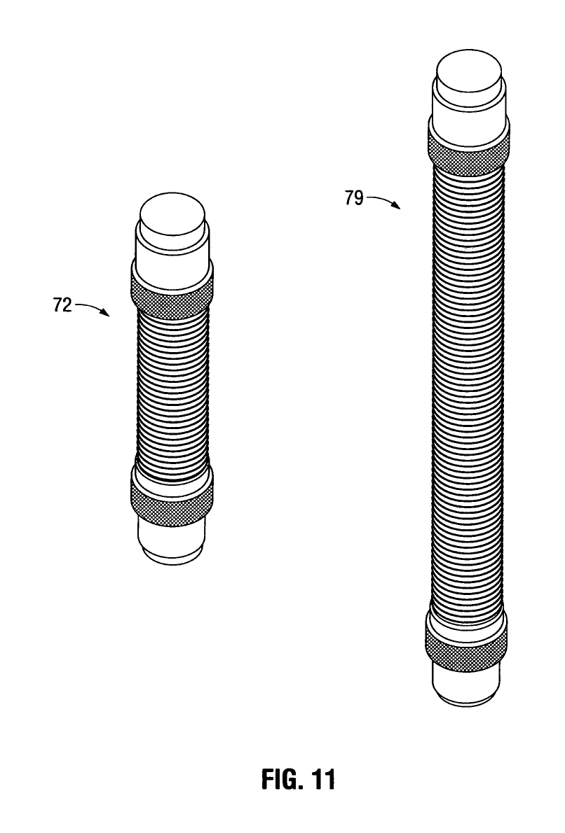

Referring now to FIG. 11, there is illustrated an exemplary magnetic probe (72, 79) which can be used in practicing the invention. The invention can be practiced through the use of a single such probe, as for example probe 72 or probe 79, but preferably as both probes 72 and 79 as discussed herein above with respect to FIG. 9. Operation. The gear ring 50 and its thirty extensions 52 are, in the preferred embodiment, fabricated from a ferrite material, for example, 4140 steel. However, the gear ring can be made, in a less preferable embodiment, from aluminum, for various reasons, including costs, ease of manufacture, weight and lack of oxidation. Aluminum is generally characterized as being non-magnetic. However, aluminum acts as if it is magnetic when subjected to a moving magnetic field. In 1833, Heinrich Emil Lenz formulated what is now known as “Lenz's Law”, which states that when a current is induced, it always flows in a direction that will oppose the change in magnetic field that causes it.

Be that as it may, the preferred embodiment of the invention calls for the gear ring and its extensions to be fabricated from a ferrite material, and more preferably, from 4140 steel. The other components of the electronic probe housing according to the invention are preferably fabricated from aluminum.

The magnetic pickup device can be purchased from many different sources, such as Daytronics Corporation, 2566 Kohnle Drive, Miamisburg, Ohio (USA) 45312, for example, their model no MP1A.

A magnetic pickup is essentially a coil wound around a permanently magnetized probe. When discrete ferromagnetic objects—such as gear teeth, turbine rotor blades, slotted discs, or shafts with keyways—are passed through the probe's magnetic field, the flux density is modulated. This induces AC voltages in the coil. One complete cycle of voltage is generated for each object passed.

If the objects are evenly spaced on a rotating shaft, the total number of cycles will be a measure of the total rotation, and the frequency of the AC voltage will be directly proportional to the rotational speed of the shaft.

(Output waveform is a function not only of rotational speed, but also of gear-tooth dimensions and spacing, pole-piece diameter, and the air gap between the pickup and the gear-tooth surface. The pole-piece diameter should be preferably less than or equal to both the gear width and the dimension of the tooth's top (flat) surface; the space between adjacent teeth should be approximately three times this diameter. Ideally, the air gap should be as small as possible, typically 0.005 inches. Thus, the devices 72 and 79 should be located, not quite touching, but very near to the extended elements 52 when the gear ring 50 is spinning.

Referring further to the embodiment of FIGS. 1B and 1C, the values to be used in the governor are first set, as is well known in this art. In the preferred embodiment, first assume that both magnetic sensors 72 and 79 are in place, one for measuring the RPM of the drive shaft causing the load to spin, and the other to generate electricity to operate the system, including the governor. However, if desired both of the sensors 72 and 79 can each be used to measure the RPM of the drive shaft, or both can be used to generate electricity. Also, the invention contemplates the use of more than two such sensors with lengths chosen for the tasks to be performed.

The governor preferably is set to allow some degree of speed change without adjusting the valve or valves, commonly referred to as “lead-lag” compensation. For example, the desired RPM may be set at 200 RPM, ±5 RPM. In this example, the valve or valves will not be changed so long as the RPM as determined by the probe 72 or 79, as the case may be, to be between 195 RPM and 205 RPM. Once the RPM is outside the range of 195-205 RPM for a given time interval, for example, for ten (10) seconds, then the valve or valves will be adjusted to bring the RPM to the desired range, as appropriate.

As an additional important feature of the present invention, the back plate 30 of FIG. 6A has the six (6) mounting holds 200, 202, 204, 206, 208 and 210 there-thru which allow the electronic probe housing in accordance with the invention to be used, without any significant modification, with all existing makes and models of commercially available steam turbines throughout the world.

There has thus been illustrated and described herein an electronic probe, according to the invention, housing which is easily mounted onto nearly every make and model of steam turbines, characterized by an inner chamber in the housing surrounding a first end of a drive shaft upon which the turbine blades are mounted, and being further characterized as having a gear ring within the inner chamber fixedly attached to the first end of the drive shaft. The gear ring has a plurality of spaced extensions, fabricated preferably from a ferrite material, and even more preferably from 4140 steel. At least one, preferably two magnetic pickup sensors are mounted at least partially, within the inner chamber of the housing in near proximity to the spaced extensions as the gear ring revolves with the drive shaft while the magnetic pickup device or devices remain stationary within the housing. During the operation of the steam turbine, the electronic probe housing automatically sends electric signal to an electronic governor which, with no human intervention, will cause the RPM of the steam turbine to increase, decrease or remain constant.

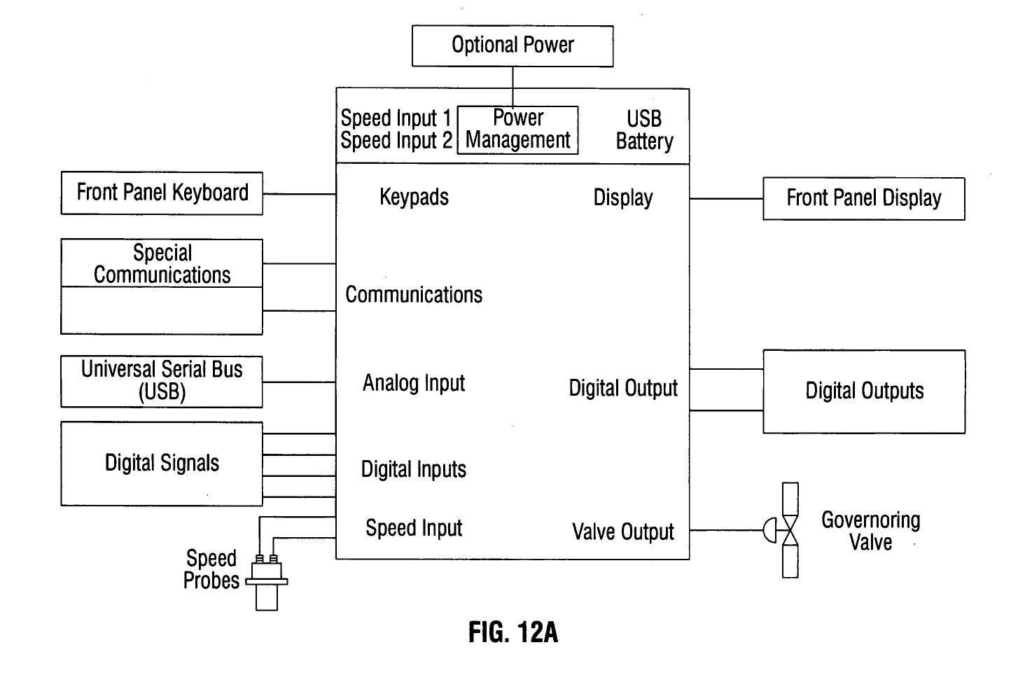

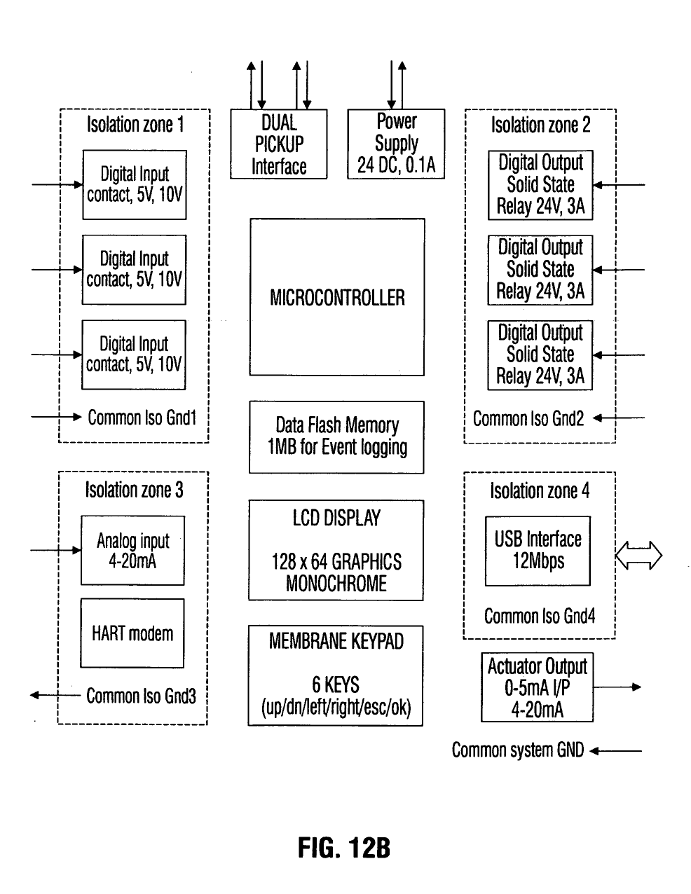

Referring now to FIG. 12A, there is illustrated a non-specific, generalized block diagram of a self powered governor according to the present invention.

The self powered governor typically is designed to be used in turbomachinery products that have a single valve operating the fuel or power for the equipment. In particular, steam turbines are a good candidate for this type of governor. Therefore, this description will assume as the preferred embodiment a governor for a single valve steam turbine.

This design is a configurable governor where the user may enter various parameters that allow the operation of the fixed program to execute. The parameters may be input either through the front panel keypad, the Universal Serial Bus (USB) interface or the special communications interface. The configuration allows for items such as the tuning characteristics for the control, indication of how input and output signal perform, and other items needed for control and protection.

The inputs include the speed measurement, digital signals, analog signals, communication ports and the keyboard. The outputs include the valve output, digital outputs for operation and indication, and the front panel display for prompting the user and providing indication of the operation of the governor. The power management for the governor allows of self-powering through the speed inputs, USB or battery. Optionally, the power can be derived from an external power source.

The speed probes can be either a self-powering type or standard passive probe. If the speed inputs are a self-powering type, the voltage is derived from the input signal and used by the power management section of the governor.

The digital signals can be configured for various operations including pushbuttons, such as start, stop or trip. Other configurations may be used for various operation modes within the governor.

The USB and special communication ports are used for monitoring, configuration and changing parameters. The front keypad is used for manual entry of those same parameters or viewing variable information.

The valve output section can output an analog signal either in a lower amperage range for the self-power mode or a higher amperage range in the powered mode.

The digital outputs are also configurable for operation and monitoring functions.

The display provides speed information and other items useful for operation of the system. It also allows feedback when configuring items with the front keypad.

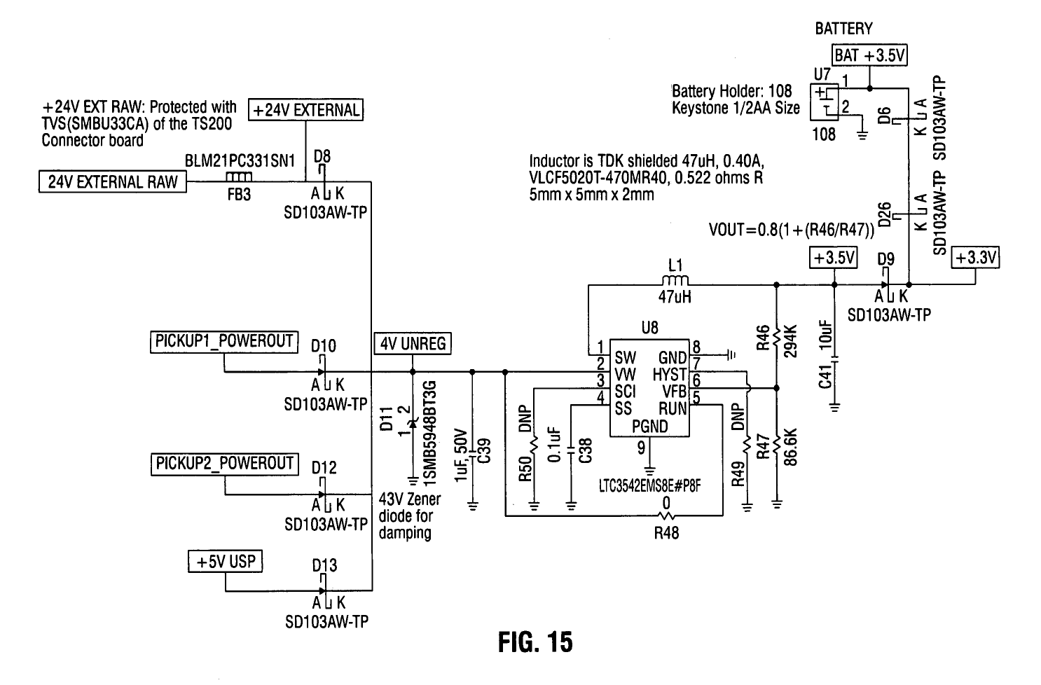

Referring now to FIG. 12B, there is illustrated in block diagram the self powered steam turbine generator according to the invention, wherein the self powered governor according to the invention enables an extremely low powered operation. The electronic schematic for operating the governor in FIG. 12B is illustrated and described with respect to FIG. 15. As illustrated in FIGS. 12B and 15, it should be appreciated that it is contemplated that the system according to the present invention can operate from the following power sources:

1) An internal battery;

2) A 24VDC external power source;

3) Harvested power from magnetic pickup 1;

4) Harvested power from magnetic pickup 2; and

5) Universal serial bus.

The internal battery is meant for startup operation when no other power source is available or for brief periods of power outage. During normal operation the battery power is not used and it is expected that the disposable lithium chemistry battery will not need to be replaced for at least 5 years. As seen from the schematic above power is not drawn from the internal battery if any of the other power sources is available. This is accomplished by diode-Oring the battery power that is at 3.3 volts and the locally derived power through a switching regulator at 3.6 volts. Battery power is not used as long as the 3.6 volt power is available.

The input power sources to the switching regulator can come from any of the following: 24 volt external power source, magnetic pickup 1, magnetic pick 2, universal serial bus. All the sources are diode-Ored such that the source with the highest voltage contributes all the power.

The system can be configured through a universal serial bus (USB) communication link to a personal computer (PC). A standard USB communication link can also supply power (up to 500 mA at 4.75 volts) and the system derives isolated power from the USB.

The 24V external power source is commonly available on the factory floor and can be used if the system is intended to drive actuators or other devices that have a larger power requirement than the 6ma i/p actuators recommended for use in a self powered configuration.

### Self Powered Governor (SPG)

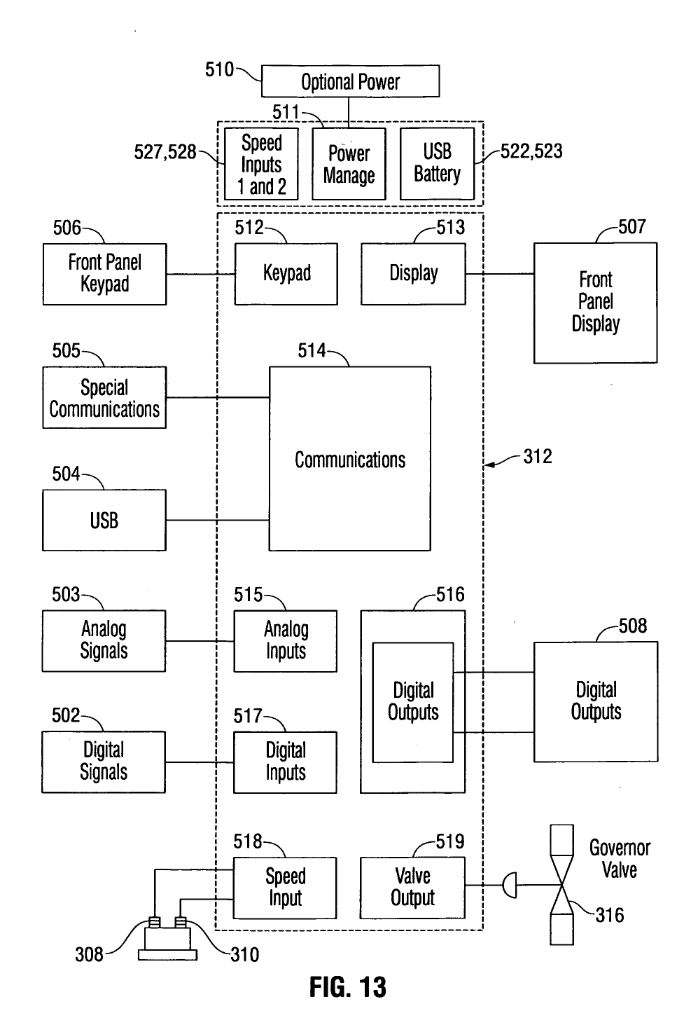

In FIG. 13, there is shown in more detail the system according to the invention. FIG. 13 shows the electronics of the Self Powered Governor (SPG) from the input signals coming from the rotating equipment, for example, the steam turbine 302 illustrated in FIG. 1B and external signals supplied to the input of the valve 316 controlling the equipment and external signals.

As with any system said to be “self-powered”, a question can be raised as to whether the system, if closed or isolated, conflicts with the well-known empirical law of conservation of energy. A consequence of this law of physics, in its simplest form, is that energy can neither be created nor destroyed, it can only be transformed from one state to another.

Although the electrical power generated by the rotation of the steam generator could be used to heat the water, and thus create the steam driving the steam generator from the steam source (314, 414), the system according to the invention will preferably not have such a feature. Thus, there will be no conflict with the conservation of energy.

The Speed Probes (308 and 310) consist of either a passive magnetic pickup or a special, high powered pickup (527,528) that provide power to the SPG when the toothed wheel, and the rotating equipment, are turning at enough RPM for the electronics of the system to detect speed. This signal is processed by the Speed Input circuitry (518) for the speed measurement.

The external Digital Signals (502) consist of various options that are processed by the Digital Inputs circuitry (517) to provide information to the SPG on how it should operate, including, but not limited, to start, stop, trip, raise speed, lower speed.

The external Analog Signals (503) consist of various options that are processed by the Analog Input circuitry (515). The signals may represent a speed setpoint or some other variable signals that change operation of the SPG.

The external communications interface can be either a Universal Serial Bus (USB) (504) or some other special communication to process the Communications circuitry (514) for operation, configuration, or other information gathering device.

The Front Panel Keypad (506) and the Front Panel Display (507) are used to communicate information to the operator or provide the operator to interact with the SPG. This is accomplished through the input, Keypad and Keypad circuitry (512) and the output, Display and Display circuitry (513).

During the operation of the SPG, certain optional signals can be provided through the Digital Outputs circuitry (516) to the external Digital outputs (508). This may be various output signals such as trip, run, etc.

The SPG provides a signal from the Valve Output circuitry (519) to the Governing Valve (316) to control the speed of the equipment. This signal can be either a low current signal for self powered operation or a high current signal in the powered configuration.

The Power Management circuitry (511) provides the power to the electronics of the SPG. This is done by either Speed Input 1 (527), Speed Input 2 (528), USB (523), Battery 5(23) or external Optional Power (510). This allows for flexibility and power conservation by the Power Management circuitry (511). The SPG runs in two powered modes, external or self powered. Then external Optional Power (510) is provided, the circuitry detects this and operates in the powered mode. Otherwise it operates in the self powered mode.

In powered mode all power is derived from the optional Power (510) source including allowing a high out put voltage to the Governing Valve (316). In the self powered mode, the power is derived in various was. One way is the Battery (23). The battery will provide the source of the SPG during the period when no other source is available. When a key is pressed, the Battery (523) will provide power to the display so that the operator can interact with the SPG. In another mode, if a start command is issued by the Keypad (512), a Digital Signal (502), being processed by the Communications module (514) the battery then operates the SPG until a speed is detected by the Speed Input (518) or logic executes to put the system in the stopped mode. At other times the Battery (523) does not provide power when one end of a USB (524) cable is plugged into the SPG and the other end is plugged into a power source.

### Logic

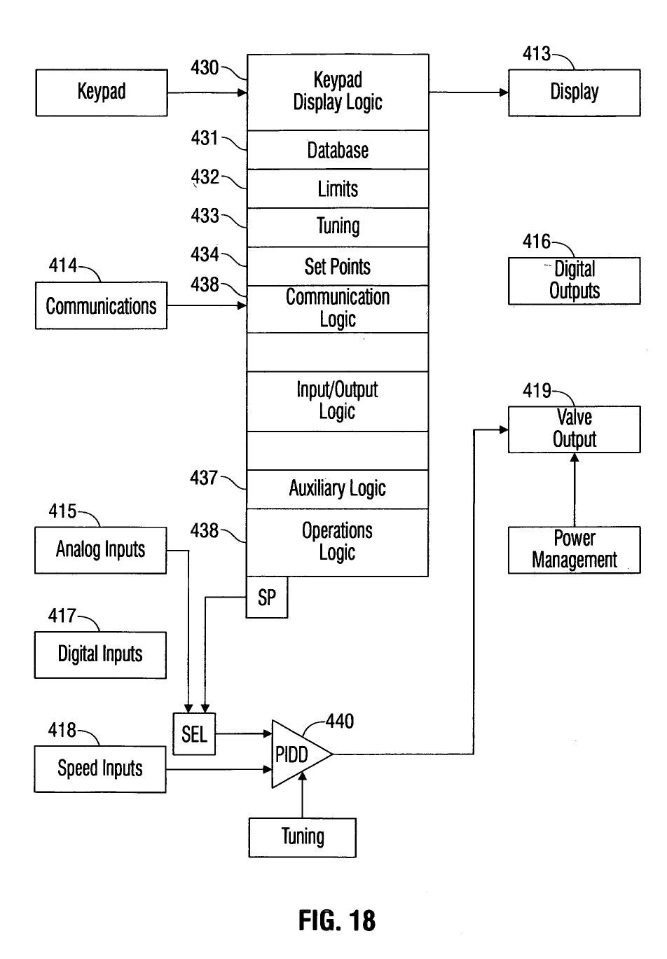

At the center of the SPG as illustrated in FIG. 18 is the Database (431). The Database (431) contains the operating parameters of the SPG or configuration. This allows for a wide range of operating scenarios depending on the type, manufacturer or process surrounding the rotating equipment. There are two ways of entering information or retrieve data from the Database (431); The Keypad/Display Logic (430) or the Communications Logic (438). Each SPG will contain a default configuration when the unit is manufactured. The Database (431) contains information such as operating Limits (432), tuning parameters (433) used by the Proportional-Integral-Derivative-Droop (PIDD) controller (440), local

Setpoint (SP) (434), how the inputs (414, 415, 417, 418) and outputs (413, 416, 419) are processed, the Operation Logic (438) that controls how the unit performs and Aux Logic (437) which provide sequencing and parameters for different operating modes.

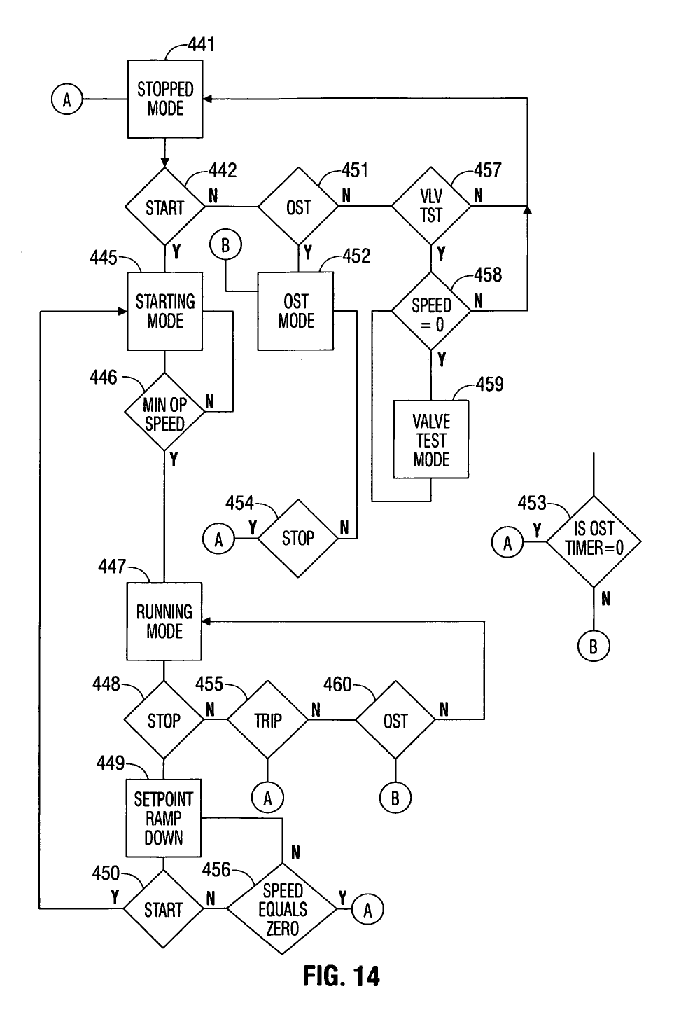

FIG. 14 illustrates the sequencing modes in the SPG. The SPG starts out in the Equipment Stopped Mode (441) which makes sure the Valve Output (519) is in the closed position. The next step is to check for a Start command (442) is received. If it is not, then the sequence moves to the next test for Overspeed Test (OST) (451). If the Start command (442) is received, then the SPG moves into Equipment Starting Mode (445). Here, the SPG starts ramping the Speed Setpoint (434, 449) to increase the speed of the rotating equipment. When the Minimum Operation Speed (446) is reached, then the SPG moves into the Equipment Running Mode (447). Here the speed or load can be maintained, raised or lowered as required. During this mode, Stop (448),

Trip (455) and OST (460) are monitored in case the mode needs to change. If Stop (448) is received, then the mode changes to Ramp Setpoint Down (449) and monitors if a Start (450) is received or if the Speed is equal to zero (456). If a Start (450) is received then, the mode changes to Equipment Starting Mode (445). If the Speed reaches zero (456), then the mode is reset to Equipment Stopped Mode (441). If a Trip (455) is sensed then the mode also changes to Equipment Stopped Mode (441).

When the OST mode (451) or (460) is checked for true state, then the OST Mode (452) is entered allowing an overspeed test to be performed from the SPG. This mode stays active until the OST Timer (453) expires or a Stop (454) is received.

Referring now to FIG. 15, there is illustrated a power supply schematic for the electronic governor according to the invention. As illustrated in FIG. 15, the invention contemplates that the system can operate from the following power sources:

1) Internal battery;

2) 24V DC external power source

3) Harvested power from magnetic pickup 1

4) Harvested power from magnetic pickup 2

5) Universal serial bus.

The internal battery is meant for startup operation when no other power source is available or for brief periods of power outage. During normal operation the battery power is not used and it is expected that the disposable lithium chemistry battery will not need to be replaced for at least 5 years. As seen from the schematic above, power is not drawn from the internal battery if any of the other power sources is available. This is accomplished by diode-Oring the battery power that is at 3.3 volts and the locally derived power through a switching regulator at 3.6 volts. Battery power is not used a long as the 3.6 volt power is available.

The input power sources to the switching regulator can come from any of the following: 24 volt external power source, magnetic pickup 1, magnetic pickup 2, universal serial bus. All the sources are diode-Ored such that the source with the highest voltage contributes all the power.

The TS300 can be configured through a universal serial bus) USB) communication link to a personal computer (PC). A standard USB communication link can also supply power (up to 500 mA at 4.75 volts) and the system derives isolated power from the USB.

The 24V DC external power source is commonly available on the factory floor and can be use if the system is intended to drive actuators or other devices that have a larger power requirement than the 6 mA i/p actuators recommended for use in a self powered configuration.

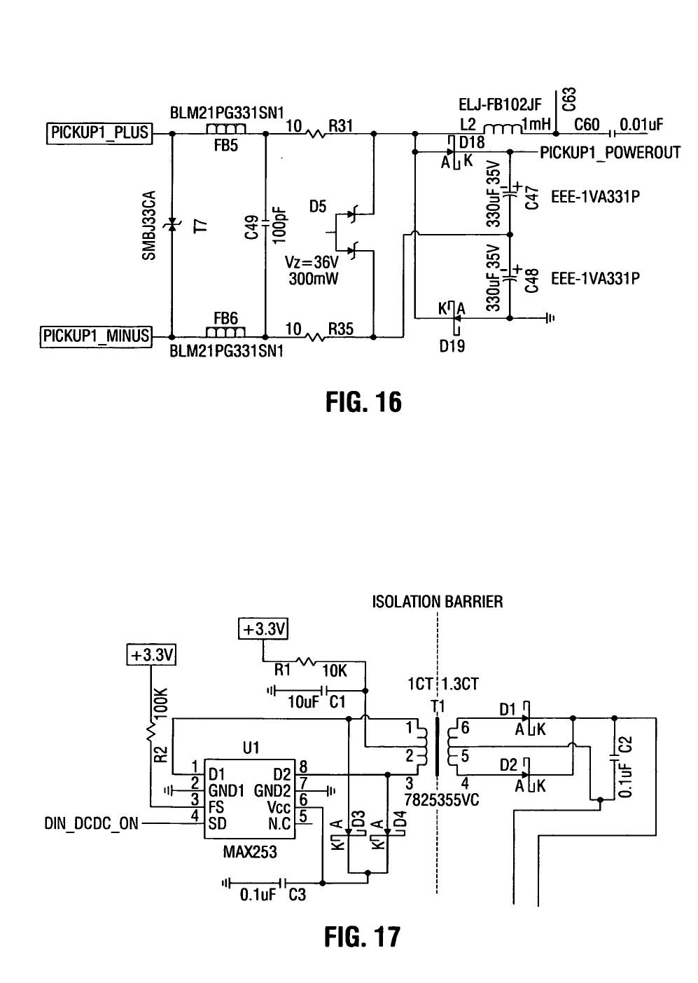

Referring now to FIG. 16, there is a schematic of a system according to the invention for harvesting the power from the use of one or more of the magnetic pickup devices, for example, those illustrated in FIG. 11.

Power harvesting from the magnetic pickups is shown in FIG. 16. The magnetic pickup recommended for use with the system is designed for intrinsically safe operation and has a built-in zener diode that limits the voltage to 8V volts. A voltage doubling scheme with two diodes and two capacitors generates approximately 15 volts and thus permits self powered operation even at low turbine speeds.

Referring now to FIG. 17, there is illustrated an isolated power source according to the invention.

The system uses an DC to DC converter built using a integrated circuit driver (MAX253) and a transformer. Full wave rectification and filtering with a capacitor generates an isolated power source. The driver can be enabled/disabled under microprocessor software control.

### Low Power Operation Techniques

The system controls the turbine using a closed loop PIDD control scheme that reads various inputs (digital, analog), computes the actuator drive requirement to keep the speed constant, and then writes various outputs (digital, analog) as needed. This read-compute-write cycle is performed once every 20 milliseconds (50 times per second).

Reading the digital inputs and the analog inputs, and driving the analog outputs and digital outputs consumes electrical energy. The system according to the invention minimizes these energy requirements by enabling different sections of the electronics very briefly (between 0.1 to 0.3 milliseconds) as needed and them disabling them for a major portion (19.7 to 19.9 milliseconds) of the 20 milliseconds read-compute-write cycle. This efficient duty cycling (between 0.5% and 1.5%) of sections the electronics allows the entire system electronics (excepting the actuator) to operate with less than 2 milliamps of current at 3.6 volts. The recommended actuator requires between 0 and 6 milliamps of current (depending on actuator setting) thus allowing the system to operate with less than 8 mA at 3.6 volts for a total power consumption of less than 30 milliwatts.

1. A self powered system for governing the speed of rotation of the drive shaft of a steam turbine, comprising:
A first sub-system for determining the speed of rotation of a steam turbine drive shaft in said system;
A second sub-system for supplying power to said governing system from a plurality of power sources, said plurality of power sources comprising a first magnetic pickup device and a second magnetic pickup device, wherein said first and second magnetic pickup devices are used in the said first sub-system for determining the speed of rotation of the steam turbine driveshaft in the system.

2. The self-powered system according to claim 1, comprising in addition thereto, electronic circuitry and/or software in said system for controlling a modulation valve used to supply the amount of steam provided to the steam turbine to reduce, increase or maintain constant the rotational speed of the steam turbine drive shaft.

3. The system according to claim 1, wherein said plurality of power sources also comprises
an internal battery;
an internal power source; and
a universal serial bus.

4. The system according to claim 3 wherein said external power source comprises 24VDC.

5. A method for supplying power to an electronic governor used to control the rotational speed of a steam turbine drive shaft, comprising:
providing a plurality of power sources to said electronic governor;
providing electronic circuitry and/or software to control which of said plurality, at power sources should be used to power the electronic governor, wherein the selection of the power source to be used from the plurality of power sources is accomplished automatically without any human intervention.

6. The method according to claim 5, wherein the selection process is determined by which of the plurality of power sources has the highest voltage available at the time of selection.

7. The method according to claim 6, wherein the plurality of power sources comprises at least two of the following:
an internal battery;
a 24VDC external power source;
harvested power from magnetic pickup 1;
harvested power from magnetic pickup 2; and
universal serial bus.

8. The method according to claim 6, wherein the plurality of power sources comprises at least three of the following:
an internal battery;
a 24VDC external power source;
harvested power from magnetic pickup 1;
harvested power from magnetic pickup 2; and
universal serial bus.

9. The method according to claim 6, wherein the plurality of power sources comprises at least four of the following:
an internal battery;
a 24VDC external power source;
harvested power from magnetic pickup 1;
harvested power from magnetic pickup 2; and
universal serial bus.

10. The method according to claim 6, wherein the plurality of power sources comprises all five of the following:
an internal battery;
a 24VDC external power source;
harvested power from magnetic pickup 1;
harvested power from magnetic pickup 2; and
universal serial bus.

11. The method according to claim 6, wherein the plurality of power sources comprises at least the following:
an internal battery;
a 24VDC external power source;
harvested power from magnetic pickup 1;
harvested power from magnetic pickup 2; and
universal serial bus.

12. A method for minimizing the power requirements for an electronic governor in controlling the rotational speed of a steam turbine drive shaft, comprising the steps of:
using a control loop PIDD control process to read various inputs from different sections of the electronics used in the electronic governor;
computing the stem valve actuator drive requirements to keep the rotational speed of the steam turbine drive shaft at a constant value;
writing additional outputs, as needed, based upon the results of the read-compute cycle; and
periodically repeating the read-compute-write cycle.

13. The method according to claim 12 wherein the read-compute-write cycle is repeated 50 times per second.

14. The method according to claim 13, wherein the different sections of the electronics in the governor, save for the valve actuator electronics, are each enabled only for brief periods of each cycle and are each disabled for a major portion of each cycle.

15. The method according to claim 14, wherein each of the electronic sections, save for the valve actuator electronics, are enabled for a period of 0.1 to 0.3 milliseconds per cycle.

16. The method according to claim 15, wherein each of the electronic sections, save for the valve actuator electronics, are disabled for a period of 19.7 to 19.9 milliseconds per cycle.
